(19) United States
(12) Patent Application Publication
(10) Pub. No.: US 2026/0126465 A1
(43) Pub. Date: May 7, 2026

(54) VEHICLE WHEEL SPEED MEASURING DEVICE AND METHOD, AND ROLL AND BRAKE INSPECTION SYSTEM USING THE SAME

(71) Applicants: Hyundai Motor Company, Seoul (KR); Kia Corporation, Seoul (KR)

(72) Inventors: Young Wook Lee, Hwaseong (KR); Jaemin Lee, Hwaseong (KR)

(21) Appl. No.: 19/338,867

(22) Filed: Sep. 24, 2025

(30) Foreign Application Priority Data
Sep. 30, 2024 (KR) 10-2024-0132603

(51) Int. Cl. G01P 3/38; G06T 7/246

(52) U.S. Cl. CPC G01P 3/38; G06T 7/246; G06T 2207/10016; G06T 2207/30252

(57) ABSTRACT

A vehicle wheel speed measuring device may be incorporated into a roll and brake inspection system. The vehicle wheel speed measuring device includes a vision sensor that captures wheel images of driving wheels of a vehicle from a side of the vehicle to be inspected, and a control unit for calculating a wheel speed over time by analyzing real-time wheel images collected from the vision sensor based on one or more wheel characteristics, such as recognized time-series spoke shapes, profile lines, or spoke spacing.

### CROSS-REFERENCE TO RELATED APPLICATION

This application claims under 35 U.S.C. § 119(a) the benefit of Korean Patent Application No. 10-2024-0132603 filed with the Korean Intellectual Property Office on Sep. 30, 2024, the entire contents of which are incorporated herein by reference.

### BACKGROUND

### (a) Technical Field

The present disclosure relates to a vehicle wheel speed measuring device and method and a roll and brake inspection system using the same, more particularly, to the vehicle wheel speed measuring device that incorporates an external vision sensor and the roll and brake inspection system using the same.

### (b) Description of the Related Art

Typically, finished vehicles assembled at automobile factories undergo a roll and brake (R/B) inspection process, and if they are determined to pass inspection, they are shipped out. If any such finished vehicles are found to be defective (NG), the vehicles may undergo a repair process.

FIG. 9 (PRIOR ART) is a view schematically illustrating a configuration of a roll and brake (R/B) inspection device of the prior art.

Referring to FIG. 9, a R/B inspection device 1 of the prior art adjusts a wheel base to suit a vehicle type to be inspected, and when a tire 4 of the vehicle is positioned on a driving roller 2, a retaining roller 3 is raised and then the driving roller 2 is operated to perform a R/B inspection. At this time, an inspector may board the vehicle and sequentially conduct a high-speed driving test based on acceleration, a traction test and an electronic stability control (ESC) test based on a neutral (N) gear, a braking test based on a brake operation, and an anti-lock braking system (ABS) test.

This conventional R/B inspection device 1 performs the R/B inspection using the roller speed measured using an encoder 5 installed at the shaft end of the driving roller 2. For example, a braking force test formula used in the R/B inspection is F=ma. Here, F represents a force, and refers to values such as a vehicle pulling force and a braking force in the R/B inspection device 1. The m is a mass constant value, for example, it has an equivalent weight of about 500 kg per each roll and is guaranteed through a mass constant value called a roller factor that is set internally in an equipment. The a refers to an acceleration/deceleration, which is derived by counting pulses output through the encoder 5 in a control panel to derive a speed value and calculating the acceleration/deceleration in real time.

However, the conventional R/B inspection method using the encoder 5 has a disadvantage in that a slippage may occur between the tire 4 and the driving roller 2 due to the dispersion in the spacing of the retaining roll 3 or the sudden braking by the inspector, which may cause a defect in the performance. For example, when the inspector fails to maintain the appropriate brake pressure during the R/B inspection and applies the brakes suddenly, a momentary gap occurs between the tire 4 of the vehicle and the drive roller 2 driven by the friction, causing the slippage. Such slippage causes false failures in the items of the traction inspection, the ESC inspection, the braking inspection, and the ABS inspection during the R/B inspection. These cause problems such as a low pass rate during the R/B inspection and increased unnecessary inspection process man-hours (M/H).

The above information disclosed in this Background section is only for enhancement of understanding of the background of the disclosure and therefore it may contain information that does not form the prior art that is already known in this country to a person of ordinary skill in the art.

### SUMMARY

An embodiment of the present disclosure provides a vehicle wheel speed measuring device and a roll and brake inspection system using the same, which may fundamentally prevent a problem of false defects caused by the slippage between the vehicle and the drive roller during the conventional encoder speed-based roll and brake (R/B) inspection by directly measuring the wheel speed of the vehicle through a vision sensor disposed on the side of the roll and brake (R/B) inspection device and supporting performing the R/B inspection based on the measured wheel speed.

According to the present disclosure, a vehicle wheel speed measuring device includes: a vision sensor that captures wheel images of driving wheels of a vehicle from a side of the vehicle to be inspected; and a control unit configured to calculate a wheel speed over time by analyzing the wheel images collected from the vision sensor based on one or more wheel characteristics.

Exemplary wheel characteristics may include, for example, wheel spoke shapes, wheel profile lines, and/or wheel spoke spacing, or other wheel features.

A vehicle may include the vehicle wheel speed measuring device.

According to one aspect of the present disclosure, a vehicle wheel speed measuring device includes a vision sensor that captures wheel images of driving wheels from a side of a vehicle to be inspected; and a control unit calculating a wheel speed over a time by analyzing real-time wheel images collected from the vision sensor and considering recognized time-series spoke shapes, profile lines, and/or spoke spacing.

The controller may extract a spoke shape image recognized from the real-time wheel image to generate a wheel speed measuring image, set a profile line according to the same singular point as the adjacent spoke shapes in the generated image, and then measure the spoke spacing in real time based on the profile line to calculate a wheel speed over a time.

The controller may calculate the real-time wheel speed by dividing the spoke spacing by a spoke detection time.

The controller may calculate the spoke spacing by dividing the tire circumference by the number of spokes.

The controller may calculate the spoke detection time (T) by multiplying the number of pixels per a predetermined time of the spoke spacing.

The controller may perform an image processing algorithm for removing image recognition impediments of the spoke shape image immediately before generating the wheel speed measuring image.

The image processing algorithm may include a cluster processing of identifying the outline of a spoke shape forming a cluster pixel in the spoke shape image and processing the illumination values of pixels included within the outline similarly; a noise removal step for checking the minimum distance between pixels and determining a pixel clustering in the spoke shape image to determine and delete the illuminance values that are different from the actual spoke shape as a noise; and an illuminance equalization step of detecting illuminance values in real time from the spoke shape image and processing illuminance value deviations within a valid shape into equalized values.

According to the present disclosure, a roll and brake inspection system includes: a roll and brake (R/B) inspection device equipped with a driving roller and a retaining roller corresponding to at least one of front wheel or rear wheel positions of a vehicle; a wheel speed measuring device configured to capture a wheel image of the vehicle by using a vision sensor during a R/B inspection; and a controller configured to analyze the wheel image collected from the vision sensor to calculate a wheel speed based on one or more wheel characteristics (e.g., the recognized spoke shape, profile line, and/or spoke spacing), and controlling the R/B inspection device based on the wheel speed to perform the R/B inspection of the vehicle.

According to another aspect of the present disclosure, a roll and brake inspection system using a vision sensor includes a roll and brake (R/B) inspection device equipped with a driving roller and a retaining roller corresponding to the front wheel (LF, RF) and rear wheel (LR, RR) positions of a vehicle that has entered the inspection stand; a wheel speed measuring device capturing images of the driving wheel of the vehicle by using a vision sensor during a R/B inspection; and a controller analyzing the wheel image collected from the vision sensor to calculate a real-time wheel speed by considering the recognized spoke shape, profile line, and spoke spacing, and controlling the R/B inspection device based on the wheel speed to perform the R/B inspection of the vehicle.

The controller may include an external interface unit that is connected to a scanner, an antenna, and the vision sensor installed on a site to collect various information required for the R/B inspection; a motor driver selectively driving the motor of the drive roller according to the feedbacked wheel speed; a programmable logic controller (PLC) checking whether the driving roller is abnormal; a display unit for displaying an information collected or generated during the R/B inspection of the vehicle on a screen; and a control unit collecting a vehicle type and a sequence information, a vehicle status information, and a wheel image of the vehicle through the external interface unit, and controlling the R/B inspection based on the collected information.

The wheel speed measuring device may include a supporter for fixing the vision sensor to the side of the wheel of the vehicle; and a moving module installed at the lower part of the supporter, and sliding and moving along the guide rail to the front or rear wheel position.

The control unit may identify the driving wheel of the vehicle based on the vehicle type and sequence information, and move the vision sensor installed so as to be able to slide through the guide rail and the moving module to the position of the driving wheel.

The controller may generate a wheel speed measurement image by using a spoke shape image recognized from the wheel image, sets the profile line to the adjacent spoke shapes, and then measure the spoke spacing in real time based on the profile line to calculate the wheel speed according to the spoke detection time.

The controller may feedback the wheel speed to the motor drive unit to drive each motor of the drive roller corresponding to a non-driven wheel of the vehicle at the same speed as the wheel speed.

According to the present disclosure, a vehicle wheel speed measuring method includes steps of: capturing, by a vision sensor, wheel images of driving wheels of a vehicle from a side of the vehicle to be inspected; and calculating, by a control unit, a wheel speed over time by analyzing the wheel images collected from the vision sensor based on one or more wheel characteristics (e.g., the recognized spoke shape, profile line, and/or spoke spacing).

In addition, the wheel images may be obtained in real time.

### BRIEF DESCRIPTION OF THE DRAWINGS

FIG. 1 is a view schematically illustrating a roll and brake inspection system using a vehicle wheel speed measuring device according to an embodiment of the present disclosure.

FIG. 2 is a view showing a control configuration of a roll and brake inspection system according to an embodiment of the present disclosure.

FIG. 3 is a flow chart schematically illustrating an R/B inspection method using a vehicle wheel speed measuring device according to an embodiment of the present disclosure.

FIG. 4 is a flow chart illustrating a vehicle wheel speed measuring method according to an embodiment of the present disclosure.

FIG. 5 is a view showing items considered when calculating a wheel speed in a tire wheel according to an embodiment of the present disclosure, and FIG. 6 is a view showing a wheel speed measurement image for measuring a spacing between spokes in real time.

FIG. 7 is a view showing a spoke-shaped image processing state according to an image processing algorithm according to an embodiment of the present disclosure.

FIG. 8 is a view showing an example of a wheel speed calculation over time considering a spoke spacing according to an embodiment of the present disclosure.

FIG. 9 (PRIOR ART) is a view schematically illustrating a configuration of a roll and brake (R/B) inspection device of the prior art.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the present disclosure will be described more fully hereinafter with reference to the accompanying drawings, in which embodiments of the disclosure are shown.

The terminology used herein is for the purpose of describing particular embodiments only and is not intended to be limiting of the present disclosure. As used herein, the singular forms are intended to include the plural forms as well, unless the context clearly indicates otherwise

Throughout the specification, terms such as “first”, “second”, “A”, “B”, “(a)”, “(b)”, etc. may be used to describe various elements, but the elements should not be limited by the terms. These terms are used only to differentiate the components from other components, but the nature, sequence, order, etc. of the corresponding components are not limited by these terms.

Also, in this specification, it is to be understood that when one component is referred to as being “connected” or “coupled” to another component, it may be connected or coupled directly to the other component or may be connected or coupled to the component with another component intervening therebetween. On the other hand, in this specification, it is to be understood that when one component is referred to as being “connected or coupled directly” to another component, it may be connected or coupled to the other component without another component intervening therebetween.

Terms used in the present specification are used only to describe specific embodiments, and are not intended to limit the present invention. Singular expressions used herein include plural expressions unless they have definitely opposite meanings in the context.

Additionally, it is understood that one or more of the methods or aspects thereof below may be executed by at least one controller. The term “controller” may refer to a hardware device that includes a memory and a processor. The memory is configured to store program instructions, and the processor is specifically programmed to execute the program instructions to perform one or more processes described in more detail below. The controller may control the operation of units, modules, components, devices, or the like, as described herein. Additionally, it is understood that the methods below may be implemented by a device including a controller together with one or more other components, as will be appreciated by those skilled in the art.

Now, a vehicle wheel speed measuring device and a roll and brake inspection system using the same according to an embodiment of the present disclosure will be described in detail with reference to attached drawings.

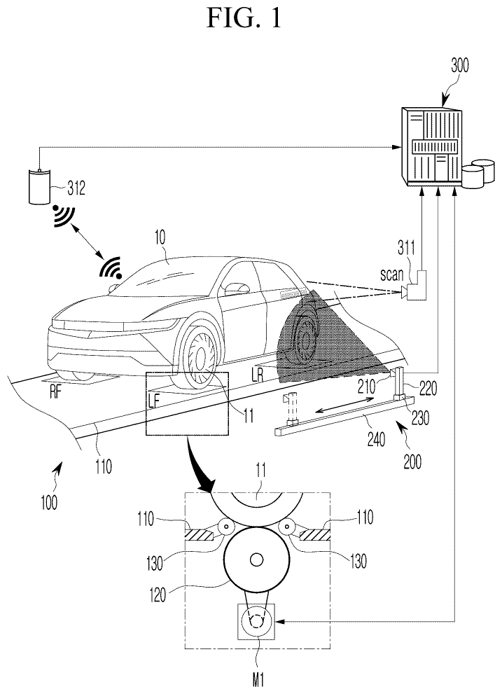

FIG. 1 is a view schematically illustrating a roll and brake inspection system using a vehicle wheel speed measuring device according to an embodiment of the present disclosure.

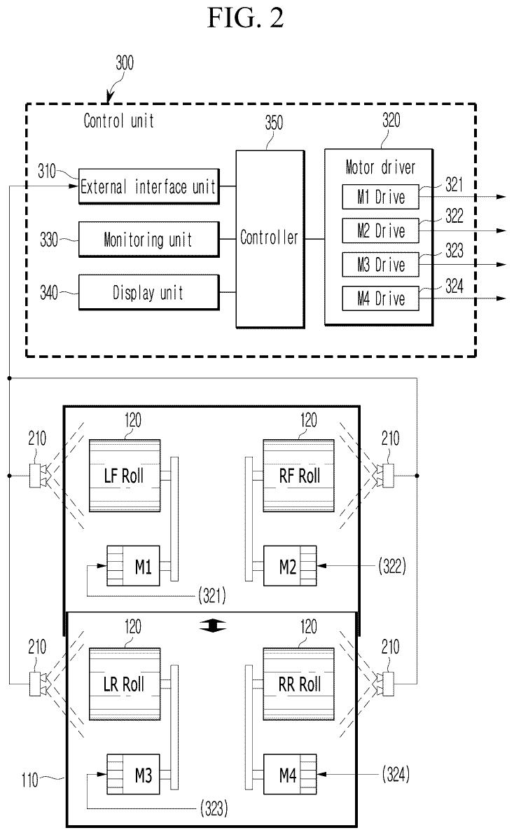

FIG. 2 is a view showing a control configuration of a roll and brake inspection system according to an embodiment of the present disclosure.

Referring to FIG. 1 and FIG. 2, a roll and brake inspection system according to an embodiment of the present disclosure largely includes a roll and brake (R/B) inspection device 100, a wheel speed measuring device 200, and a control device 300.

The R/B inspection device 100 is equipped with a driving roller 120 and a retaining roller 130 corresponding to the positions of the front wheels LF and RF and the rear wheels LR and RR of the vehicle 10 loaded (aligned) on an inspection stand 110, respectively.

The wheel speed measuring device 200 captures an image of the driving wheel of the vehicle 10 by using a vision sensor 210 during the R/B inspection.

The control device 300 analyzes the wheel image collected from the vision sensor 210 to calculate a real-time wheel speed and controls the R/B inspection device 100 based on the calculated wheel speed to perform the R/B inspection of the vehicle 10. The wheel speed has the same meaning as a speed of a vehicle (i.e., a vehicle speed).

The roll and brake inspection system according to the embodiment of the present disclosure may be installed in a production line of an automobile factory to perform the R/B inspection before the shipment of the completed vehicle. In addition, it is not limited thereto, it may be installed in a vehicle maintenance shop to perform the R/B inspection on a customer vehicle 10.

The vehicle 10 may be an internal combustion engine (ICE), an electronic vehicle (EV), a hybrid electronic vehicle (HEV), a fuel cell electronic vehicle (FCEV), etc., including a complete vehicle.

The wheel speed measuring device 200 is not limited to the roll and brake inspection system, and may be applied to other research/test facilities that require the tire wheel speed measurement while mounted or not on the vehicle 10. For example, other research/test facilities may be research/test facilities, or brake performance testing facilities, that require the wheel speed measurement while rotating the tire/wheel after being mounted.

However, as a preferred embodiment to help understand the present disclosure, the description will continue below assuming the roll and brake inspection system referring to FIG. 1 and FIG. 2.

As shown in FIG. 1, the vehicle 10 to be inspected has four tire wheels LF, RF, LR, and RR aligned on the driving roller 120 of the R/B inspection device 100.

At this time, the inspection stand 110 adjusts the spacing between the drive rollers 120 of the front wheels LF and RF and the rear wheels LR and RR to suit the wheel base according to the vehicle type (including various options and specifications) and the sequence (the order of the entry into the process) of the vehicle 10.

The R/B inspection device 100 may prevent the detachment of the tire wheels LF, RF, LR, and RR by raising the retaining roller 130 installed in the front and rear of the driving roller 120.

Each motor M1, M2, M3, and M4 configured in the front wheels LF and RF and the rear wheels LR and RR selectively operates during the R/B inspection depending on the front/rear wheel drive vehicle type to drive the corresponding drive roller 120.

For example, when the front wheels of the vehicle 10 are driven, the drive roller 120 equipped on the front wheels LF and RF rotates due to an inertia, and the drive roller 120 equipped on the rear wheels LR and RR is driven by the corresponding motors M3 and M4 and rotates based on the real-time wheel speed. Conversely, when the rear wheels of the vehicle 10 are driven, the drive roller 120 equipped on the rear wheels LR and RR rotates by an inertia, and the drive roller 120 equipped on the front wheels LF and RF is driven by the corresponding motors M1 and M2 and rotates based on the real-time wheel speed.

This R/B inspection device 100 has a structure in which the encoder for measuring the speed of the conventional driving roller is omitted (deleted).

Meanwhile, as explained above, the conventional R/B inspection method conducted the inspection based on the roller speed measured by using the encoder, and at this time, there was the disadvantage in causing the defect due to the slip between the vehicle and the driving roller.

Accordingly, the wheel speed measuring device 200 according to the improved embodiment of the present disclosure includes a control means that recognizes the spoke shape of the tire wheel 11 of the vehicle 10 by utilizing a 3D vision sensor 210 equipped with a plurality of visions (cameras) to set a profile line suitable for the spoke shape, and then measures the wheel speed in real time to be utilized for the R/B inspection. The above control means may be integrated into the control device 300. However, the embodiment of the present disclosure is not limited thereto, and if necessary, the control means may be independently configured in the wheel speed measuring device 200 and may be connected to another control device 300 to enable mutual interoperability.

The wheel speed measuring device 200 is placed on the mounting surface relative to the R/B inspection device 100.

The wheel-mounted measuring device 200 may include a supporter 220 for fixing the vision sensor 210 to the side of the wheel 11 of the vehicle 10 as a mechanical element, and a movement module 230 installed at the lower part of the supporter 220 and sliding along a guide rail 240 to the front or rear wheel position.

The movement module 230 may horizontally move the vision sensor 210 to the position of the tire wheel 11 of the front or rear wheel according to the R/B inspection method of the front or rear wheel drive vehicle type. Therefore, the wheel speed of the front/rear tires may be selectively measured according to the R/B inspection method by using one vision sensor 210. These moving modules 230 and guide rails 240 may be implemented using a linear motion (LM) guide system.

The control device 300 is implemented as a computing system that controls the overall operation of the R/B inspection device 100 and the wheel speed measuring device 200.

For example, the control device 300 includes an external interface unit 310, a motor driving unit 320, a programmable logic controller (PLC) 330, a display unit 340, and a control unit 350.

The external interface unit 310 is connected to a scanner 311, an antenna 312, and a vision sensor 210 installed on a site to collect various information required for the R/B inspection.

At this time, the scanner 311 may scan the barcode or the QR code of the vehicle 10 that entered the inspection stand 110 and transmit the recognized vehicle type and sequence information to the external interface unit 310.

In addition, the antenna 312 may connect a wireless communication of the vehicle 10 that has entered the inspection stand 110 and collect the vehicle status information such as a starting ON/OFF, an anti-lock braking system (ABS) valve operation information (ON/OFF), an accelerator position sensor (APS) value, and a brake pedal sensor (BPS) value, and transmit the collected information to the external interface unit 310.

In addition, the vision sensor 210 may capture the image of the rotating tire wheel in real time during the R/B inspection to be transmitted to the external interface unit 310.

The motor driving unit 320 selectively drives the motors M1, M2, M3, and M4 of the driving roller 120 according to the wheel speed fed back from the control unit 350.

The motor driving unit 320 includes a first drive 321 that transmits a driving command to the first motor M1, a second drive 322 that transmits a driving command to the second motor M2, a third drive 323 that transmits a driving command to the third motor M3, and a fourth drive 324 that transmits a driving command to the fourth motor M4.

The PLC 330 performs a monitoring function to check for abnormalities in the driving roller 120 according to the operation of the R/B inspection device 100 and to transmit/receive the speed data to check for abnormalities.

The display unit 340 displays an information collected or generated during the R/B inspection of the vehicle 10 on the screen.

The display unit 340 may display on the screen the results of the tests related to the R/B braking including the traction of the vehicle 10, an electronic stability control (ESC), a braking force, and a ABS, and a work instruction information such as an acceleration and a braking while the R/B test is in progress.

The control unit 350 controls R/B inspection for multi-type and/or multi-specification of the vehicle 10 produced at an automobile factory, and includes at least one program and data for this purpose.

The control unit 350 may collect the vehicle type and the sequence information, the vehicle status information, and the wheel images of the vehicle 10 that has entered the inspection stand 110 through the external interface unit 310, and control the R/B inspection based on this.

The control unit (350) may be implemented as one or more processors operating according to a set program, and the set program may be programmed to perform each step of the R/B inspection method for vehicle wheel speed measurement according to an embodiment of the present disclosure.

Hereinafter, the R/B inspection method for the vehicle wheel speed measurement according to an embodiment of the present disclosure will be described through drawings, and the description of the control unit 350 will be concretized through this.

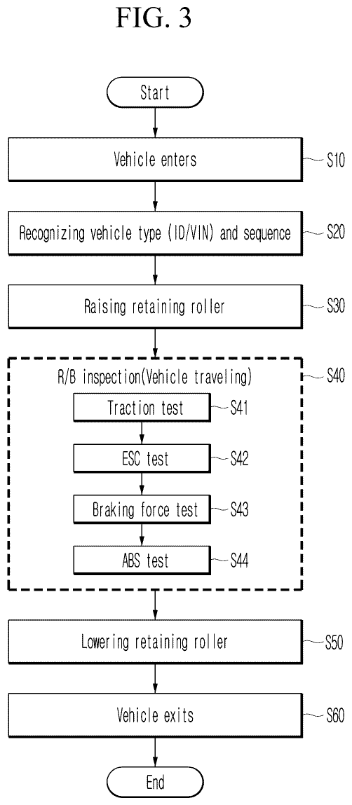

FIG. 3 is a flow chart schematically illustrating an R/B inspection method using a vehicle wheel speed measuring device according to an embodiment of the present disclosure.

Referring to FIG. 3, the R/B inspection method based on the vehicle wheel speed measurement according to an embodiment of the present disclosure will be explained assuming that the R/B inspection process is performed on the vehicle 10 assembled at an automobile factory.

When the vehicle 10 enters the R/B inspection device 100 (S10), the control unit 350 of the roll and brake inspection system scans the barcode of the vehicle 10 through the scanner 311 to recognize the vehicle type (ID/VIN) and the sequence (S20). At this time, the control unit 350 may adjust the spacing between the driving rollers 120 of the front wheels LF and RF and rear wheels LR and RR of the R/B inspection device 100 to match the wheel base of the recognized vehicle type (ID/VIN). In addition, if the recognized vehicle type (ID/VIN) is the front-wheel drives LF and RF, the control unit 350 may move the vision sensor 210 that is installed to be able to slide through the guide rail 240 and the moving module 230 to the position of the driving wheels LF and RF of the vehicle 10.

The control unit 350 raises the retaining roller 130 when the vehicle 10 is aligned to the R/B inspection position to prevent the tire wheels LF, RF, LR, and RR from coming off (S30).

When the wireless communication with the vehicle 10 is connected through the antenna 312, the control unit (350) determines that the preparation for the R/B inspection is complete and transmits a work command to the vehicle 10 to initiate the R/B inspection (S40). At this time, the inspector will start the driving of the vehicle after confirming the above work commands. Accordingly, the vehicle 10 goes through the R/B inspection process by the R/B inspection device 100 while driving according to the work commands.

For example, the control unit 350 may perform an R/B inspection process including at least one of a traction test step (S41) and an ESC test step (S42) in a neutral gear condition while the vehicle 10 is driving, a braking force test step (S43) and an ABS test step (S44) in the brake operation (ON) condition, through the R/B inspection device 100. Here, the above-mentioned traction force test step (S41) tests a natural deceleration force according to a drive system resistance of the vehicle 10. The ESC test step (S42) applies only to ICE vehicles and tests whether the operation is achieved after a forced valve operation. The braking force test step (S43) measures the braking force applied to each wheel when the brake pedal is pressed while the vehicle is driving. At this time, if the braking force per the wheel is below the standard, it is determined as defective (NG). In addition, a braking force balance test may be performed and if the braking force deviation between the left and right wheels is within a certain range, it may be judged as normal (OK). The ABS test step (S44) forcibly operates the ABS valve in the order of individual tire wheels (FL-RF-RL-RR) to check whether the valve is operating normally, and through this, whether the ABS brake tube line is normally assembled may be determined.

At this time, the control unit 350 is characterized by analyzing the image of the driving wheels LF and RF of the vehicle 10 captured through the vision sensor 210 to directly measure the real-time wheel speed and perform the R/B test based on the wheel speed. For example, the control unit 350 may measure the wheel speed of a certain inspection section (0 to 120 km/hr) from the image of the tire wheel driven by the vehicle 10.

When the R/B inspection is completed, the control unit 350 lowers the retaining roller 130 (S50).

The control unit 350 is terminated (S60) when the vehicle 10 exits the R/B inspection device 100.

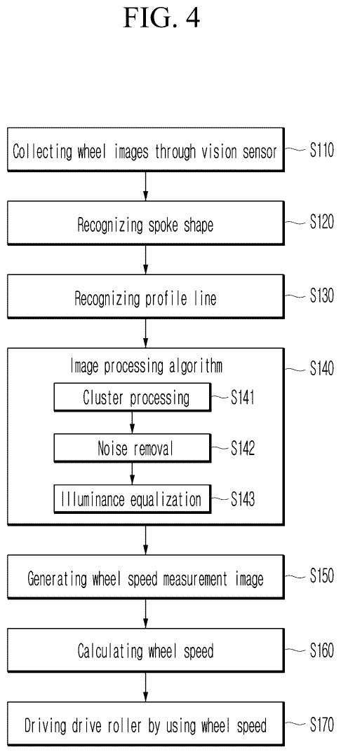

Meanwhile, FIG. 4 is a flowchart showing a vehicle wheel speed measuring method according to an embodiment of the present disclosure.

Referring to FIG. 4, when the acceleration and the R/B inspection of the vehicle 10 start, the control unit 350 executes a vehicle wheel speed measurement program and collects the wheel images captured through the vision sensor 210 (S110).

In the factory, various wheels are applied according to the vehicle type and/or specification of the vehicle 10, and therefore, the spoke shape and the profile line applied to the shape are different according to the vehicle type.

The control unit 350 analyzes the wheel images collected through the vision sensor 210 to recognize the spoke shape and number (S120), and recognizes the specific (settable) profile line considering the spoke shape (S130). The profile line serves as a reference for measuring the spacing between the neighboring spoke shapes in the future, and at this time, it may be set in a cross shape based on a singular point of the spoke shape.

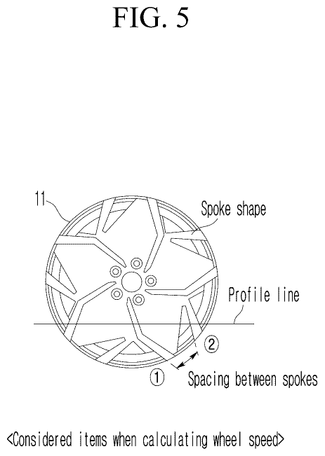

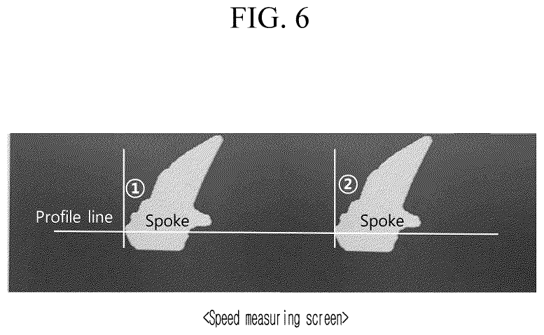

For example, FIG. 5 is a view showing items considered when calculating a wheel speed in a tire wheel according to an embodiment of the present disclosure, and FIG. 6 is a view showing a wheel speed measurement image for measuring a spacing between spokes in real time.

First, referring to FIG. 5, in order to calculate the wheel speed based on the wheel image of the tire wheel 11, the spoke shape (the image), the profile line, and the spacing between the spoke shapes (hereinafter referred to as “a spoke spacing”) are considered as essential items.

That is, the control unit 350 may analyze the real-time wheel images collected from the vision sensor 210 and calculate the real-time wheel speed over time by considering the recognized spoke shape (image), profile line, and spoke spacing.

Next, referring to FIG. 6, the control unit 350 the generates a wheel speed measurement image (screen) for measuring the spacing between the spokes in real time for the wheel speed calculation.

Specifically, the control unit 350 extracts the spoke shape image recognized from the real-time wheel image to generate the wheel speed measurement image, and sets the profile line to match the same singular point as the adjacent spoke shapes in the generated image. Additionally, the control unit 350 may measure the spoke spacing in real time based on the profile line and calculate the wheel speed depending on the time.

However, before generating the wheel speed measurement image such as that in FIG. 6, if there are image recognition impeding factors (e.g., a noise, etc.) in the spoke shape image extracted from the wheel image, the accuracy of the wheel speed may be affected.

Accordingly, the control unit 350 performs an image processing algorithm to remove the image recognition impediments of the spoke shape image before generating the wheel speed measurement image to improve the accuracy of the wheel speed calculation (S140). The image processing algorithm includes a cluster processing step (S141), a noise removal step (S142), and an illuminance equalization step (S143) for the spoke shaped image (an original image).

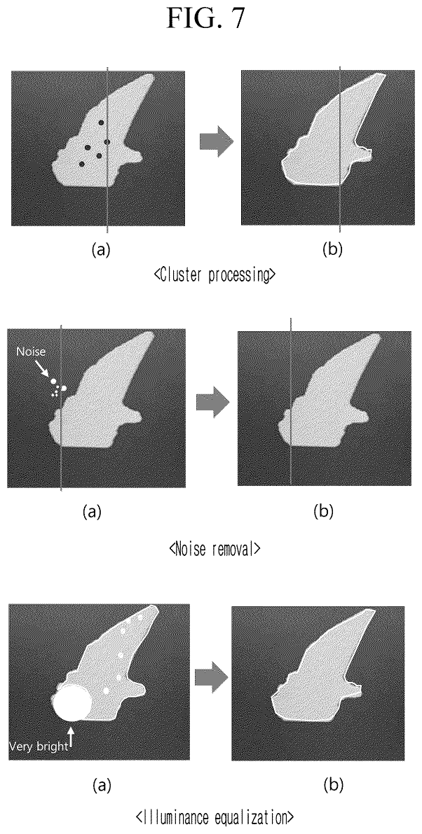

For example, FIG. 7 is a view showing a spoke-shaped image processing state according to an image processing algorithm according to an embodiment of the present disclosure.

Referring to FIG. 7, the original image (a) and the processed image (b) are compared and shown when the cluster processing step (S141), the noise removal step (S142), and the illuminance equalization step (S143) of the image processing algorithm according to an embodiment of the present disclosure are performed.

The cluster processing step (S141) is described.

The original image may include empty pixels (i.e., blank pixels) within the spoke shape due to an irregular reflection, etc. If the blank pixels are detected as a profile line, a wheel speed measurement error may occur.

Accordingly, the control unit 350 identifies the outline of the spoke shape forming the cluster pixels in the original image and similarly processes the illumination values of the pixels included within the outline.

Therefore, it is possible to prevent the speed measurement errors due to the pixel removal, such as in processed images.

The noise removal step (S142) is described.

If there is a noise in the original image, this may reduce the reliability of the speed measurement.

Accordingly, the control unit 350 determines the minimum distance between the pixels in the original image and identifies the pixel clusters to determine and delete the illumination values that are different from the actual spoke shape as the noise.

Therefore, the noise may be removed such as in the processed image, and the resulting decrease in the measurement reliability may be prevented.

The illuminance equalization step (S143) is described.

Even if a valid spoke shape is searched for in the original image, if the deviation in the illumination value for each pixel is large, it may not be recognized as a single shape or may be distorted.

Accordingly, the control unit 350 detects the illuminance value in real time from the original image and processes the illuminance value deviation within the valid shape into a normalized value to improve the recognition rate of the spoke shape.

The control unit 350 generates a wheel speed measurement image by using the spoke shape image from which the image recognition impediments have been removed through the image processing algorithm, and sets the profile line on the adjacent spoke shapes (S150). Then, the spoke spacing is measured in real time based on the profile line and the wheel speed is calculated according to the spoke detection time (S160).

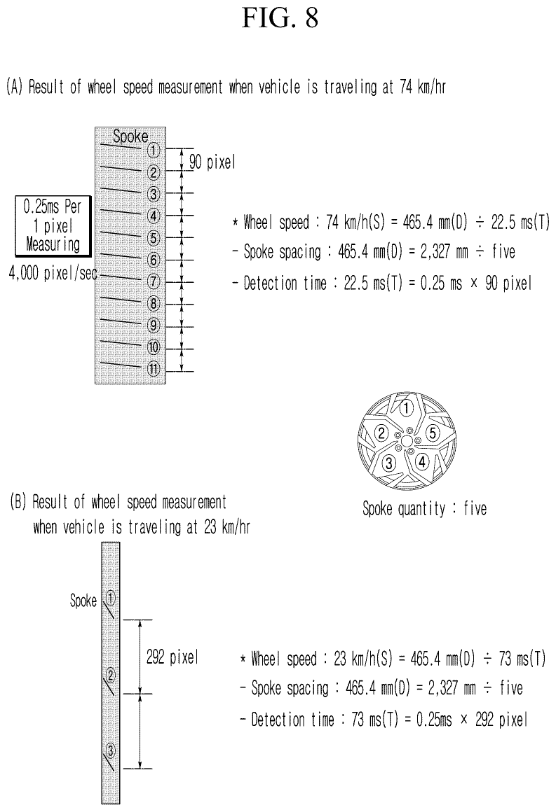

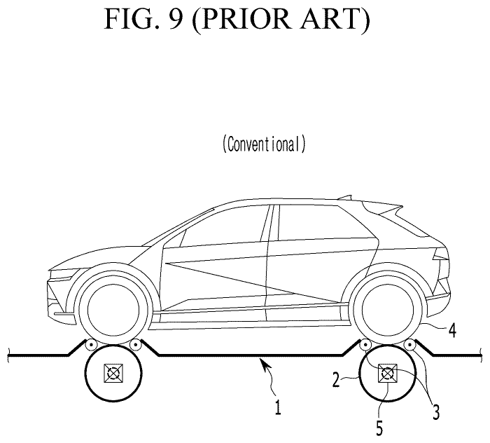

FIG. 8 is a view showing an example of a wheel speed calculation over a time considering a spoke spacing according to an embodiment of the present disclosure.

Referring to FIG. 8(A), an example of a calculation method is shown along with a result of a wheel speed measurement when a vehicle is traveling at 74 km/hr.

The control unit 350 may calculate the real-time wheel speed S by dividing the spoke spacing D by the spoke detection time T (e.g., 74 km/h(S)=465.4 mm (D)÷22.5 ms (T)).

Here, the spoke spacing D may be calculated by dividing the circumferential length of the tire of the driving wheel by the number of spokes (e.g., 465.4 mm (D)=2,327 mm÷5).

The spoke detection time T may be calculated by multiplying the spoke spacing D by the number of pixels per a predetermined time (90 pixels) (e.g., 22.5 ms (T)=0.25 ms×90 pixels).

Similarly, referring to FIG. 8(B), an example of a calculation method is shown based on the result of the wheel speed measurement when the vehicle is traveling at 23 km/hr.

The control unit 350 may calculate the real-time wheel speed S by dividing the spoke spacing D by the spoke detection time T (e.g., 23 km/h(S)=465.4 mm (D)÷73 ms (T)).

Here, the spoke spacing D is the same as that in FIG. 8(A) and the spoke detection time T acts as a variable.

The control unit 350 may feed-back the calculated wheel speed to the motor drive unit 320 to drive each motor M3 and M4 of the drive roller 120 corresponding to the non-driven wheel (e.g., the rear wheels RF and RR) at the same speed as the wheel speed (S170).

In this way, according to an embodiment of the present disclosure, by setting the profile line that matches the shape of the wheel spoke of the vehicle photographed using the 3D vision sensor and measuring the wheel speed in real time during the driving, there is an effect of being able to directly measure the vehicle speed without a mechanical sensor such as an encoder.

In addition, by conducting the roll and brake (R/B) inspection based on the wheel speed of the vehicle measured directly without a mechanical interference with an equipment by using the 3D vision sensor, it is possible to fundamentally block the problem of a poor performance due to the slip between the vehicle and the R/B drive rollers that occurred when using the conventional roller encoder speed. In addition, this has the effect of improving the R/B test passing rate and reducing a re-test M/H.

In addition, the wheel speed may be measured in a non-contact manner by using the vision sensor installed on the outside of the vehicle, which improves the durability, and the wheel speed of the front and rear wheels may be selectively measured by using the single vision sensor that is movably installed, which has the effect of reducing an initial installation and maintenance cost.

The above-mentioned exemplary embodiments of the present invention are not embodied only by an apparatus and/or method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vehicle wheel speed measuring device comprising:
a vision sensor that captures wheel images of driving wheels of a vehicle from a side of the vehicle to be inspected; and
a control unit configured to calculate a wheel speed over time by analyzing the wheel images collected from the vision sensor based on one or more wheel characteristics.

2. The vehicle wheel speed measuring device of claim 1, wherein:
the controller extracts a spoke shape image recognized from the wheel image to generate a wheel speed measuring image, sets a profile line according to the same singular point as the adjacent spoke shapes in the generated image, and then measures the spoke spacing in real time based on the profile line to calculate a wheel speed over a time.

3. The vehicle wheel speed measuring device of claim 2, wherein:
the controller calculates the wheel speed by dividing the spoke spacing by a spoke detection time.

4. The vehicle wheel speed measuring device of claim 3, wherein:
the controller calculates the spoke spacing by dividing the tire circumference by the number of spokes.

5. The vehicle wheel speed measuring device of claim 3, wherein:
the controller calculates the spoke detection time (T) by multiplying the number of pixels per a predetermined time of the spoke spacing.

6. The vehicle wheel speed measuring device of claim 2, wherein:
the controller performs an image processing algorithm for removing image recognition impediments of the spoke shape image immediately before generating the wheel speed measuring image.

7. The vehicle wheel speed measuring device of claim 6, wherein the image processing algorithm includes:
a cluster processing of identifying the outline of a spoke shape forming a cluster pixel in the spoke shape image and processing the illumination values of pixels included within the outline similarly;
a noise removal step for checking the minimum distance between pixels and determining a pixel clustering in the spoke shape image to determine and delete the illuminance values that are different from the actual spoke shape as a noise; and
an illuminance equalization step of detecting illuminance values in real time from the spoke shape image and processing illuminance value deviations within a valid shape into equalized values.

8. The vehicle wheel speed measuring device of claim 1, wherein the wheel images are obtained in real time.

9. The vehicle wheel speed measuring device of claim 1, wherein the wheel images are analyzed by considering recognized time-series spoke shapes, profile lines, or spoke spacing.

10. A vehicle comprising the vehicle wheel speed measuring device of claim 1.

11. A roll and brake inspection system comprising:
a roll and brake (R/B) inspection device equipped with a driving roller and a retaining roller corresponding to at least one of front wheel or rear wheel positions of a vehicle;
a wheel speed measuring device configured to capture a wheel image of the vehicle by using a vision sensor during a R/B inspection; and
a controller configured to analyze the wheel image collected from the vision sensor to calculate a wheel speed based on one or more wheel characteristics, and controlling the R/B inspection device based on the wheel speed to perform the R/B inspection of the vehicle.

12. The roll and brake inspection system using the vision sensor of claim 11, wherein:
the controller includes:
an external interface unit that is connected to a scanner, an antenna, and the vision sensor installed on a site to collect various information required for the R/B inspection;
a motor driver selectively driving the motor of the drive roller according to the feedbacked wheel speed;
a programmable logic controller (PLC) checking whether the driving roller is abnormal;
a display unit for displaying an information collected or generated during the R/B inspection of the vehicle on a screen; and
a control unit collecting a vehicle type and a sequence information, a vehicle status information, and a wheel image of the vehicle through the external interface unit, and controlling the R/B inspection based on the collected information.

13. The roll and brake inspection system using the vision sensor of claim 12, wherein:
the wheel speed measuring device includes
a supporter for fixing the vision sensor to the side of the wheel of the vehicle; and
a moving module installed at the lower part of the supporter, and sliding and moving along the guide rail to the front or rear wheel position.

14. The roll and brake inspection system using the vision sensor of claim 13, wherein:
the control unit identifies the driving wheel of the vehicle based on the vehicle type and sequence information, and moves the vision sensor installed so as to be able to slide through the guide rail and the moving module to the position of the driving wheel.

15. The roll and brake inspection system using the vision sensor of claim 12, wherein:
the controller generates a wheel speed measurement image by using a spoke shape image recognized from the wheel image, sets the profile line to the adjacent spoke shapes, and then measures the spoke spacing in real time based on the profile line to calculate the wheel speed according to the spoke detection time.

16. The roll and brake inspection system using the vision sensor of claim 15, wherein:
the controller feeds back the wheel speed to the motor drive unit to drive each motor of the drive roller corresponding to a non-driven wheel of the vehicle at the same speed as the wheel speed.

17. The roll and brake inspection system of claim 11, wherein the wheel image is obtained in real time.

18. The roll and brake inspection system of claim 11, wherein the wheel image is analyzed by considering recognized time-series spoke shapes, profile lines, or spoke spacing.

19. A vehicle wheel speed measuring method comprising:
capturing, by a vision sensor, wheel images of driving wheels of a vehicle from a side of the vehicle to be inspected; and
calculating, by a control unit, a wheel speed over time by analyzing the wheel images collected from the vision sensor based on one or more wheel characteristics.

20. The vehicle wheel speed measuring method of claim 19, wherein the wheel images are obtained in real time.
